(19) United States
(12) Patent Application Publication
(10) Pub. No.: US 2025/0244016 A1
(43) Pub. Date: Jul. 31, 2025

(54) TURBOMACHINE HAVING IMPROVED MIXING TUBE ELEMENTS

(71) Applicant: GE Infrastructure Technology LLC, Greenville, SC (US)

(72) Inventors: Wei Zhao, Greer, SC (US); Wessam Sherif Estefanos, Simpsonville, SC (US); Thomas Edward Johnson, Greer, SC (US)

(21) Appl. No.: 18/425,041

(22) Filed: Jan. 29, 2024

(51) Int. Cl. F23R 3/28; F02C 7/22

(52) U.S. Cl. CPC F23R 3/28; F02C 7/22; F23R 3/286

(57) ABSTRACT

A fuel nozzle for a combustor of a turbomachine includes a housing and a plurality of mixing tube elements surrounded by the housing. At least one of the plurality of mixing tube elements includes a body extending between a first end and a second end and defining a passage extending through the body between the first end and the second end. The first end is closed, and the second end is open. The body further defines a first fluid inlet and a second fluid inlet, the first fluid inlet being defined between the first end and the second end, and the second fluid inlet being defined between the first fluid inlet and the second end.

### FIELD

The present disclosure relates generally to turbomachines, and more particularly to improved mixing tube elements for fuel nozzles of turbomachine combustors.

### BACKGROUND

Turbomachines are utilized in a variety of industries and applications for energy transfer purposes. For example, a gas turbine engine is a turbomachine that generally includes a compressor section, a combustion section, a turbine section, and an exhaust section. The compressor section progressively increases the pressure of a working fluid entering the gas turbine engine and supplies this compressed working fluid to the combustion section. The compressed working fluid and a fuel (e.g., natural gas) mix within the combustion section and burn in a combustion chamber to generate high pressure and high temperature combustion gases. The combustion gases flow from the combustion section into the turbine section where they expand to produce work. For example, expansion of the combustion gases in the turbine section may rotate a rotor shaft connected, e.g., to a generator to produce electricity. The combustion gases then exit the gas turbine via the exhaust section.

Traditional gas turbine engines include one or more combustors that burn a mixture of natural gas and air within the combustion chamber to generate the high pressure and temperature combustion gases. In some combustor sections, a primary fuel nozzle at an upstream end of the combustor injects fuel and air (or a fuel/air mixture) in an axial direction into a primary combustion zone. As a byproduct, oxides of nitrogen (NOx) and other pollutants are created and expelled by the exhaust section. Regulatory requirements for low emissions from gas turbines are continually growing more stringent, and environmental agencies throughout the world are now requiring even lower rates of emissions of NOx and other pollutants from both new and existing gas turbines.

Burning a mixture of natural gas and high amounts of hydrogen and/or burning pure hydrogen instead of natural gas within the combustor would significantly reduce or eliminate the emission of NOx and other pollutants. However, because hydrogen burning characteristics are different than those of natural gas, traditional combustion systems are not capable of burning high levels of hydrogen and/or pure hydrogen without issue. For example, burning high levels of hydrogen and/or pure hydrogen within a traditional combustion system could promote flashback or flame holding conditions in which the combustion flame migrates towards the fuel being supplied by the injector, possibly causing severe damage to the injector in a relatively short amount of time.

As such, turbomachines, combustors, and fuel nozzles capable of delivering alternative fuels (such as hydrogen) and air for combustion without causing flame holding or flashback issues are desired in the art.

### BRIEF DESCRIPTION

Aspects and advantages of turbomachines, combustors, and fuel nozzles in accordance with the present disclosure will be set forth in part in the following description, or may be obvious from the description, or may be learned through practice of the technology.

In accordance with one embodiment, a turbomachine is provided. The turbomachine includes a compressor section, a combustion section including a combustor, the combustor including an end cover and a fuel nozzle, and a turbine section. The fuel nozzle includes a plurality of mixing tube elements surrounded by a housing, at least one of the plurality of mixing tube elements including a body extending between a first end and a second end and defining a passage extending through the body between the first end and the second end, wherein the first end is closed and the second end is open. The body further defines a first fluid inlet and a second fluid inlet, the first fluid inlet being defined between the first end and the second end, and the second fluid inlet being defined between the first fluid inlet and the second end.

In accordance with another embodiment, a fuel nozzle for a combustor of a turbomachine is provided. The fuel nozzle includes a housing and a plurality of mixing tube elements surrounded by the housing. At least one of the plurality of mixing tube elements includes a body extending between a first end and a second end and defining a passage extending through the body between the first end and the second end, wherein the first end is closed and the second end is open. The body further defines a first fluid inlet and a second fluid inlet, the first fluid inlet being defined between the first end and the second end, and the second fluid inlet being defined between the first fluid inlet and the second end.

These and other features, aspects and advantages of the present turbomachines, combustors, and fuel nozzles will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present turbomachines, combustors, and fuel nozzles, including the best mode of making and using the present systems and methods, directed to one of ordinary skill in the art, is set forth in the specification, which makes reference to the appended figures, in which:

FIG. 1 is a schematic illustration of a turbomachine in accordance with embodiments of the present disclosure;

FIG. 2 is a schematic view of a combustion section as may be employed in the turbomachine of FIG. 1 in accordance with embodiments of the present disclosure;

FIG. 3 is a cross-sectional view of components of a combustor, including a fuel nozzle having a plurality of mixing tube elements in accordance with embodiments of the present disclosure;

FIG. 4 is a perspective view of a mixing tube element as may be employed in a fuel nozzle in accordance with embodiments of the present disclosure;

FIG. 5 is a cross-sectional view of a mixing tube element as may be employed in a fuel nozzle in accordance with embodiments of the present disclosure;

FIG. 6 is a cross-sectional view, along the line A-A of FIG. 5, of a mixing tube element as may be employed in a fuel nozzle in accordance with embodiments of the present disclosure;

FIG. 7 is a cross-sectional view, along the line B-B of FIG. 5, of a mixing tube element as may be employed in a fuel nozzle in accordance with embodiments of the present disclosure; and

FIG. 8 is a schematic view of an additive manufacturing system in accordance with embodiments of the present disclosure.

### DETAILED DESCRIPTION

Reference now will be made in detail to embodiments of the present turbomachines, combustors, and fuel nozzles, one or more examples of which are illustrated in the drawings. Each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components.

The term “fluid” may be a gas or a liquid. The term “fluid communication” means that a fluid is capable of making the connection between the areas specified.

As used herein, the terms “upstream” (or “forward”) and “downstream” (or “aft”) refer to the relative direction with respect to fluid flow in a fluid pathway. For example, “upstream” refers to the direction from which the fluid flows, and “downstream” refers to the direction to which the fluid flows. However, the terms “upstream” and “downstream” as used herein may also refer to a flow of electricity. The term “radially” refers to the relative direction that is substantially perpendicular to an axial centerline of a particular component; the term “axially” refers to the relative direction that is substantially parallel and/or coaxially aligned to an axial centerline of a particular component; and the term “circumferentially” refers to the relative direction that extends around the axial centerline of a particular component.

Terms of approximation, such as “about,” “approximately,” “generally,” and “substantially,” are not to be limited to the precise value specified. In at least some instances, the approximating language may correspond to the precision of an instrument for measuring the value, or the precision of the methods or machines for constructing or manufacturing the components and/or systems. In at least some instances, the approximating language may correspond to the precision of an instrument for measuring the value, or the precision of the methods or machines for constructing or manufacturing the components and/or systems. For example, the approximating language may refer to being within a 1, 2, 4, 5, 10, 15, or 20 percent margin in either individual values, range(s) of values and/or endpoints defining range(s) of values. When used in the context of an angle or direction, such terms include within ten degrees greater or less than the stated angle or direction. For example, “generally vertical” includes directions within ten degrees of vertical in any direction, e.g., clockwise or counter-clockwise.

The terms “coupled,” “fixed,” “attached to,” and the like refer to both direct coupling, fixing, or attaching (including integration via additive manufacturing), as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Here and throughout the specification and claims, where range limitations may be combined and interchanged, such ranges are identified and include all the sub-ranges contained therein unless context or language indicates otherwise. For example, all ranges disclosed herein are inclusive of the endpoints, and the endpoints are independently combinable with each other.

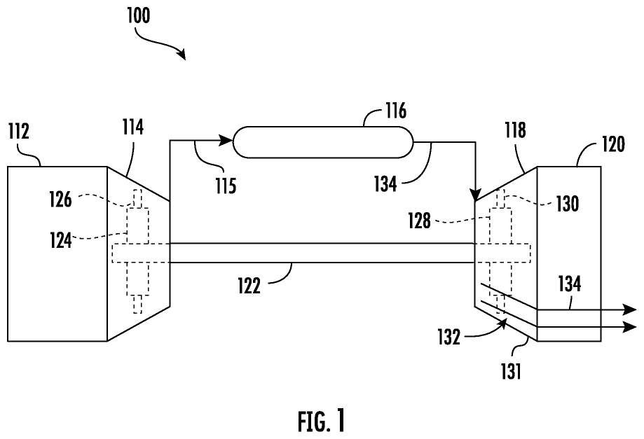

Referring now to the drawings, FIG. 1 illustrates a schematic diagram of one embodiment of a turbomachine, which in the illustrated embodiment is a gas turbine engine 100. Although an industrial or land-based gas turbine is shown and described herein, the present disclosure is not limited to an industrial or land-based gas turbine engine unless otherwise specified in the claims. For example, the technology as described herein may be used in any type of turbomachine including but not limited to a steam turbine, an aircraft gas turbine, or a marine gas turbine.

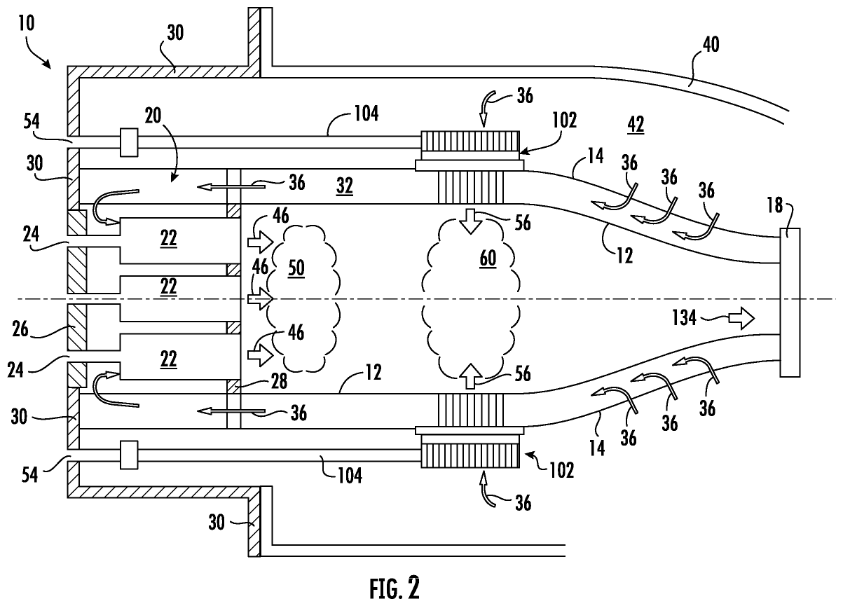

As shown, gas turbine engine 100 generally includes, in serial flow order: an inlet section 112, a compressor section 114 disposed downstream of the inlet section 112, a plurality of combustors (one of which is shown in FIG. 2) within a combustion section 116 disposed downstream of the compressor section 114, a turbine section 118 disposed downstream of the combustion section 116, and an exhaust section 120 disposed downstream of the turbine section 118. Additionally, the gas turbine engine 100 may include one or more shafts 122 coupled between the compressor section 114 and the turbine section 118.

The compressor section 114 may generally include a plurality of rotor disks 124 (one of which is shown) and a plurality of rotor blades 126 extending radially outwardly from and connected to each rotor disk 124. Each rotor disk 124 in turn may be coupled to or form an upstream portion of the shaft 122 that extends through the compressor section 114. The compressor section 114 further includes a plurality of stationary vanes (not shown), which are arranged in stages with the rotor blades 126 and which direct the flow against the rotor blades 126.

The turbine section 118 may generally include a plurality of rotor disks 128 (one of which is shown) and a plurality of rotor blades 130 extending radially outwardly from and being interconnected to each rotor disk 128. Each rotor disk 128 in turn may be coupled to or form a downstream portion of the shaft 122 that extends through the turbine section 118. The turbine section 118 further includes an outer casing 131 that circumferentially surrounds the downstream portion of the shaft 122 and the rotor blades 130, thereby at least partially defining a hot gas path 132 through the turbine section 118. The turbine section 118 further includes a plurality of stationary vanes (not shown), which are arranged in stages with the rotor blades 130 and which direct the flow against the rotor blades 130.

During operation, a working fluid such as air flows through the inlet section 112 and into the compressor section 114 where the air is progressively compressed by multiple compressor stages of rotating blades and stationary vanes, thus providing pressurized air 115 to the combustors 10 (FIG. 2) of the combustion section 116. The pressurized air 115 is mixed with fuel and burned within each combustor 10 to produce combustion gases 134. The combustion gases 134 flow through the hot gas path 132 from the combustion section 116 into the turbine section 118, in which energy (kinetic and/or thermal) is transferred from the combustion gases 134 to the rotor blades 130, causing the shaft 122 to rotate. The mechanical rotational energy may then be used to power the compressor section 114 and/or to generate electricity. The combustion gases 134 exiting the turbine section 118 may then be exhausted from the gas turbine engine 100 via the exhaust section 120.

FIG. 2 is a schematic representation of a combustor 10 in the form of a combustion can, which may be included in the combustion system 116 in FIG. 1. A plurality of combustion cans 10 (e.g., 8, 10, 12, 14, 16, or more) is positioned in an annular array about the shaft 122.

In FIG. 2, the combustion can 10 includes a liner 12 that contains and conveys combustion gases 134 to the turbine section 118. The liner 12 may have a cylindrical liner portion and a tapered transition portion that is separate from the cylindrical liner portion, as in many conventional combustion systems. Alternately, the liner 12 may have a unified body (or “unibody”) construction, in which the cylindrical portion and the tapered portion are integrated with one another. Thus, any discussion of the liner 12 herein is intended to encompass both conventional combustion systems having a separate liner and transition piece and those combustion systems having a unibody liner. Moreover, the present disclosure is equally applicable to those combustion systems in which the transition piece and the stage one nozzle of the turbine are integrated into a single unit, sometimes referred to as a “transition nozzle” or an “integrated exit piece.”

The liner 12 is surrounded by an outer sleeve 14, which is spaced radially outward of the liner 12 to define an annulus 32 between the liner 12 and the outer sleeve 14. The outer sleeve 14 may include a flow sleeve portion at the forward end and an impingement sleeve portion at the aft end, as in many conventional combustion systems. Alternately, the outer sleeve 14 may have a unified body (or “unisleeve”) construction, in which the flow sleeve portion and the impingement sleeve portion are integrated with one another in the axial direction. As before, any discussion of the outer sleeve 14 herein is intended to encompass both convention combustion systems having a separate flow sleeve and impingement sleeve and combustion systems having a unisleeve outer sleeve.

A head end portion 20 of the combustion can 10 includes one or more fuel nozzles 22. The fuel nozzles 22 have a fuel inlet 24 at an upstream (or inlet) end. The fuel inlets 24 may be formed through an end cover 26 at a forward end of the combustion can 10. The downstream (or outlet) ends of the fuel nozzles 22 extend through, or collectively define, a combustor cap 28.

The head end portion 20 of the combustion can 10 is at least partially surrounded by a forward casing 30, which is physically coupled and fluidly connected to a compressor discharge case 40. The compressor discharge case 40 is fluidly connected to an outlet of the compressor (not shown) and defines a pressurized air plenum 42 that surrounds at least a portion of the combustion can 10. Air 36 (compressed air 115 from FIG. 1) flows from the compressor discharge case 40 into the annulus 32 at an aft end of the combustion can 10. Because the annulus 32 is fluidly coupled to the head end portion 20, the air flow 36 travels upstream from the aft end of the combustion can 10 to the head end portion 20, where the air flow 36 reverses direction and enters the fuel nozzles 22.

Fuel and air are introduced by the fuel nozzles 22 into a primary combustion zone 50 at a forward end of the liner 12, where the fuel and air are combusted to form combustion gases 46. The combustion gases 46 travel downstream toward an aft end 18 of the combustion can 10. Additional fuel and air may be introduced by one or more fuel injector assemblies 102 (referred to herein as a “fuel injector” or “injector”) into a secondary combustion zone 60, where the fuel and air are ignited by the combustion gases 46 to form combustion gases 56. Fuel to fuel injector assemblies 102 is delivered through a fuel supply line 104 having an inlet 54 at a forward end of the combustor can 10. Combustion gases 46 and combustion gases 56 form a combined combustion gas product stream 134. Such a combustion system having axially separated combustion zones is described as an “axial fuel staging” (AFS) system, and the downstream injectors 102 may be referred to as “AFS injectors.”

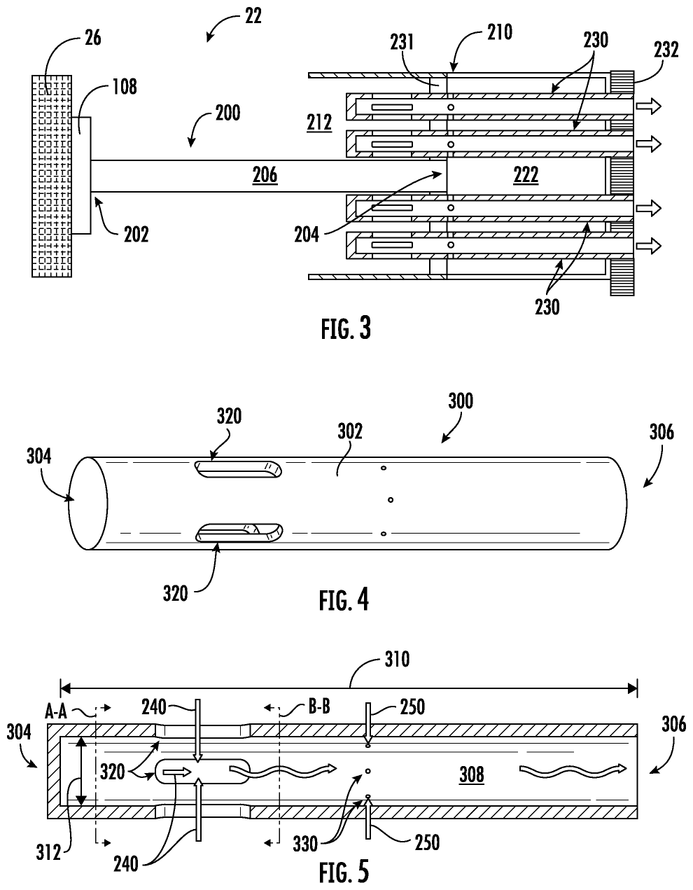

FIG. 3 illustrates various components of a combustor 10. As shown and discussed, combustor 10 may include one or more fuel nozzles 22, each of which may extend through an end cover 26 at a forward end of the combustor 10. The downstream (or outlet) ends of the fuel nozzles 22 extend through, or collectively define, a combustor cap 28 (FIG. 2), 232 (FIG. 3).

As shown in FIG. 3, fuel nozzle 22 may include a fluid delivery conduit 200 which extends between an inlet 202 and an outlet 204. Inlet 202 may be defined in the end cover 26. A fluid passage 206 through which fluid flows may be defined through the conduit 200 between the inlet 202 and outlet 204. Inlet 202 and outlet 204 may be open such that fluid may flow into the fluid passage 206 through the inlet 202 and be exhausted from the fluid passage 206 through the outlet 204. Fluid delivery conduit 200 may further include a flange 108 which connects the conduit 200 to the end cover 26. In exemplary embodiments, the fluid flowing through the fluid conduit 200 is a fuel, such as natural gas and/or hydrogen.

Fuel nozzle 22 may, in some embodiments, further include an outer housing 210 and a forward plate 231 that define a first fluid plenum 212. The outer housing 210 may surround (such as fully or at least partially) at least a portion of the conduit 200 and may further surround (such as fully or at least partially) a plurality of mixing tube elements as discussed herein.

Outlet 204 may terminate at a second fluid plenum 222. Second fluid plenum 222 may be defined by housing 210 (which may be a single component surrounding first and second fluid plenums or separate components surrounding each of first and second plenums 212, 222), the forward plate 231, and an end plate 232 (which may define or coincide with cap 28 of FIG. 2) axially spaced from the forward plate. Further, a plurality of mixing tube elements 230 may be provided, and the housing 210 may surround (such as fully or at least partially) the mixing tube elements 230. Mixing tube elements 230 may be arranged in an annular array about outlet 204 and, in some embodiments, a resonator (not shown).

Fluid, such as oxidizing or cooling fluid, may flow into first fluid plenum 212 from annulus 32 between the liner 12 and outer sleeve 14 and may flow from the first fluid plenum 212 into the mixing tube elements 230 through first fluid inlets as discussed herein. In exemplary embodiments, the fluid flowing through the first fluid plenum 212 into the mixing tube elements 230 may be air. Such fluid may be referred to as first fluid 240 herein.

The fluid flowing through the fluid conduit 200 into the second fluid plenum 222 may flow from the second fluid plenum 222 into the mixing tube elements 230 through second fluid inlets as discussed herein. Such fluid may be referred to as second fluid 250 herein.

In some embodiments, a fuel nozzle 22 may further include an end plate 232. End plate 232 may be positioned at a downstream end of the fuel nozzle 22, such as proximate downstream second ends of the mixing tube elements 230. These second ends may extend through the end plate 232 to allow fluid to be exhausted therethrough. The downstream end of the outer housing 210 may terminate at the end plate 232.

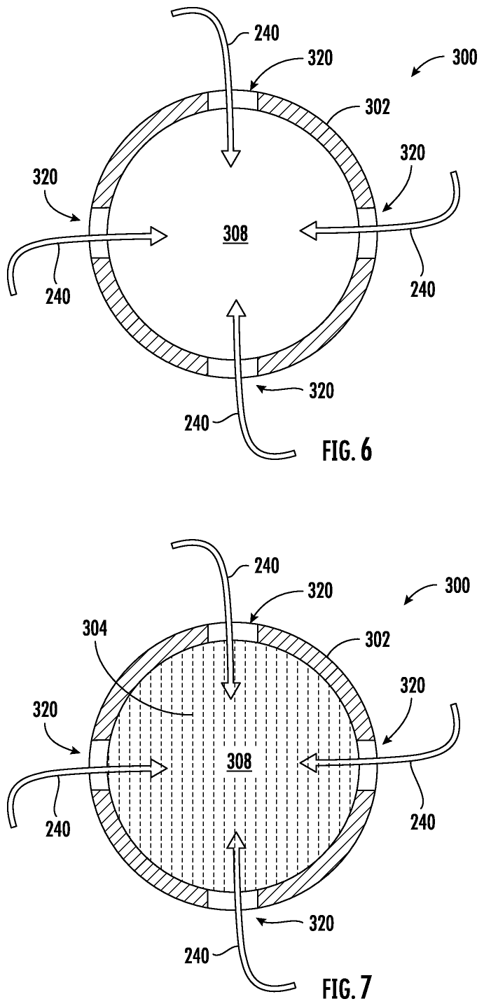

Referring now to FIGS. 4 through 7, exemplary embodiments of mixing tube elements 300 are illustrated. It should be understood that mixing tube elements 300 may be utilized as one or more, such as in some embodiments all, of the mixing tube elements 230 of a fuel nozzle 22 in accordance with embodiments of the present disclosure.

As shown, a mixing tube element 300 may include a body 302 which extends between a first (forward) end 304 and a second (aft) end 306. A passage 308 may be defined in the body 302 and may extend through the body 302 between the first end 304 and the second end 306. With reference to FIGS. 4, 5, and 7, first end 304 is closed such that no fluid flows through first end 304. With reference to FIGS. 4, 5, and 6, second end 306 is open such that fluid may be exhausted from the passage 308 through the second end 306. Second end 306 may thus function as an outlet for passage 308. A premixed combination of a first fluid 240 and a second fluid 250 as discussed herein may be exhausted from the passage 308 through the second end 306.

In exemplary embodiments, body 302 is cylindrical. Alternatively, body 302 may be conical, cubic, or have other suitable shapes. Further in exemplary embodiments, passage 308 is cylindrical. Alternatively, passage 308 may be conical, cubic, or have other suitable shapes.

Passage 308 may have a length 310 (e.g., a maximum length) defined between the first end 304 and the second end 306. Passage 308 may further have a width 312 (e.g., a maximum width). Width 312 may be a diameter in cases in which the body 302 is cylindrical.

As shown, one or more first fluid inlets 320 may be defined in the body 302, such as in some embodiments proximate the first end 304. First fluid inlets 320 may be in fluid communication with first fluid plenum 212 and passage 308, such that fluid received through first fluid inlets 320 flows into passage 308. In exemplary embodiments, first fluid 240 flows into passage 308 through first fluid inlets 320 from first fluid plenum 212.

In exemplary embodiments, a plurality of first fluid inlets 320 are defined in the body 302. Further, in particular exemplary embodiments four first fluid inlets 320 are defined in the body 302. The first fluid inlets 320 may, in exemplary embodiments as shown, be approximately equally (or, in exemplary embodiments, equally) spaced about a perimeter of the body 302. Thus, each first fluid inlet 320 is approximately equally (or, in exemplary embodiments, equally) spaced from neighboring first fluid inlets 320 about the perimeter of the body 302.

First fluid inlets 320 may be defined in the body 302 between first end 304 and second end 306 along the length 310, such as proximate to first end 304 and distal from second end 306 along the length 310. Further, in exemplary embodiments, the first fluid inlets 320 may be approximately equally (or, in exemplary embodiments, equally) spaced from the first end 304 along the length 310.

The arrangement and spacing of the first fluid inlets 320 on the body 302 is particularly advantageous, as the first fluid 240 flowing through each first fluid inlet 320 may impinge on first fluid 240 flowing through other first fluid inlets 320, such as the oppositely positioned first fluid inlet 320. For example, such impingement creates a strong turbulent flow field which facilitates improved mixing with a second fluid 250, resulting in improved premixing within mixing tube elements 300.

In exemplary embodiments, first fluid inlets 320 have elongated shapes, such as elongated slot shapes shown with a greater length (axial direction) than width (circumferential direction). Such elongated slots include linear sides and curvilinear ends, as shown. Such elongated slots have a major axis that extends in an axial direction. Alternatively, other suitable shapes, such as other suitable elongated shapes, may be utilized.

As shown, one or more second fluid inlets 330 may be defined in the body 302, such as in some embodiments proximate to the first end 304. Second fluid inlets 330 may be in fluid communication with passage 308, such that fluid received through second fluid inlets 330 flows into passage 308. In exemplary embodiments, second fluid 250 flows into passage 308 through second fluid inlets 330 from second fluid plenum 222.

In exemplary embodiments, a plurality of second fluid inlets 330 are defined in the body 302 as fluid injection ports. The second fluid inlets 330 may, in exemplary embodiments as shown, be approximately equally (or, in exemplary embodiments, equally) spaced about a perimeter of the body 302. Thus, each second fluid inlets 330 is approximately equally (or, in exemplary embodiments, equally) spaced from neighboring second fluid inlets 330 about the perimeter of the body 302.

Second fluid inlets 330 may be defined in the body 302 between first end 304 and second end 306 along the length 310, such as proximate first end 304 and distal from second end 306 along the length 310. In exemplary embodiments, second fluid inlets 330 may be between the first fluid inlets 320 and the second end 306 along the length 310. Further, in exemplary embodiments, the second fluid inlets 330 may be approximately equally (or, in exemplary embodiments, equally) spaced from the first end 304 along the length 310.

As discussed, passage 308 may have a length 310 and a width (interior diameter) 312. In exemplary embodiments, the length 310 may be less than or equal to approximately two times the width 312. Such sizing is particularly advantageous and results from the various other design characteristics discussed herein such as the arrangement and spacing of the first fluid inlets 320, the closed first end 304, etc. In particular, the length 310 to width 312 ratio is considerable shorter than that of known mixing tube element designs, which in some cases have an 8:1 length to width ratio. The smaller ratio, coupled with the improved premixing as discussed herein, advantageously reduced flameholding risk for the elements 300 and nozzle 22 generally. Additionally, the smaller ratio facilitates a shorter build time for nozzle 22, when produced by additive manufacturing as described below.

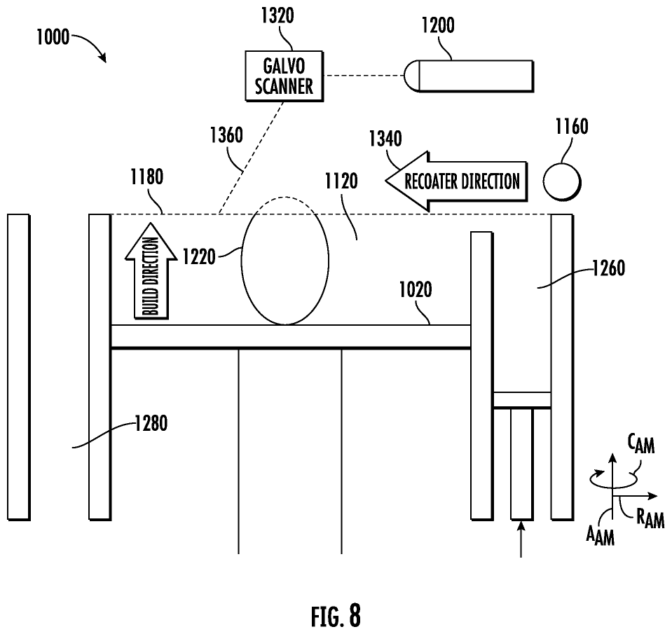

In some embodiments, fuel nozzles 22 or portions thereof (including the mixing tube elements 300, housing 210, forward plate 231, and end plate 232, which define first fluid plenum 212 and second fluid plenum 222) may be formed from an additive manufacturing system, and in some embodiments may thus be formed as a single, unitary component. An exemplary additive manufacturing system is described below with reference to FIG. 8.

To illustrate an example of an additive manufacturing system and process, FIG. 8 shows a schematic/block view of an additive manufacturing system 1000 for generating an object 1220, which may be the fuel nozzle 22 or portions thereof as discussed herein. The additive manufacturing system 1000 may be configured for direct metal laser sintering (DMLS) or direct metal laser melting (DMLM). For example, the additive manufacturing system 1000 may fabricate objects, such as the fuel nozzle 22 or portions thereof as discussed herein.

For example, the object 1220 may be fabricated in a layer-by-layer manner by sintering or melting a powder material in a powder bed 1120 using an energy beam 1360 generated by a source such as a laser 1200. The powder to be melted by the energy beam is supplied by reservoir 1260 and spread evenly over a build plate 1020 using a recoater arm 1160, which moves in a recoater direction 1340, to maintain the powder at a level 1180 and to remove excess powder material extending above the powder level 1180 to waste container 1280. The energy beam 1360 sinters or melts a cross sectional layer of the object being built under control of the galvo scanner 1320. The build plate 1020 is lowered, and another layer of powder is spread over the build plate and the object being built, followed by successive melting/sintering of the powder by the laser 1200. The process is repeated until the object 1220 is completely built up from the melted/sintered powder material.

The laser 1200 (e.g., energy beam 1360) may be controlled by a computer system including a processor and a memory. The computer system may determine a scan pattern for each layer and control laser 1200 to irradiate the powder material according to the scan pattern. After fabrication of the object 1220 is complete, various post-processing procedures may be applied to the object 1220. Post-processing procedures include removal of excess powder by, for example, blowing or vacuuming. Other post-processing procedures include a stress release process. Additionally, thermal and chemical post-processing procedures can be used to finish the object 1220.

In exemplary embodiments, the additive manufacturing system 1000 may define a cylindrical coordinate system having an axial build direction AAM (or build direction), a radial direction RAM perpendicularly to the build direction, and a circumferential direction CAM extending around the build direction.

As described, exemplary embodiments of the present subject matter involve the use of additive manufacturing machines or methods. As used herein, the terms “additively manufactured” or “additive manufacturing techniques or processes” refer generally to manufacturing processes wherein successive layers of material(s) are provided on each other to “build-up,” layer-by-layer, a three-dimensional component. The successive layers generally fuse together to form a monolithic component, which may have a variety of integral sub-components.

The additive manufacturing processes described herein may be used for forming components using any suitable material. For example, the material may be metal, ceramic, any other suitable material that may be in solid, liquid, powder, sheet material, wire, or any other suitable form. More specifically, according to exemplary embodiments of the present subject matter, the additively manufactured components described herein may be formed in part, in whole, or in some combination of materials including but not limited to pure metals, nickel alloys, chrome alloys, titanium, titanium alloys, magnesium, magnesium alloys, aluminum, aluminum alloys, iron, iron alloys, stainless steel, and nickel or cobalt based superalloys (e.g., those available under the name Inconel® available from Special Metals Corporation). These materials are examples of materials suitable for use in the additive manufacturing processes described herein and may be generally referred to as “additive materials.”

As used herein, references to “fusing” may refer to any suitable process for creating a bonded layer of any of the above materials. For example, if the material is ceramic, the bond may be formed by a sintering process. If the material is powdered metal, the bond may be formed by a melting or sintering process. One skilled in the art will appreciate that other methods of fusing materials to make a component by additive manufacturing are possible, and the presently disclosed subject matter may be practiced with those methods.

Each successive layer may be, for example, between about 10 μm (micrometers) and 200 μm (micrometers), although the thickness may be selected based on any number of parameters and may be any suitable size according to alternative embodiments. Therefore, utilizing the additive formation methods described above, the components described herein may have cross sections as thin as one thickness of an associated powder layer, e.g., 10 μm, utilized during the additive formation process.

Notably, in exemplary embodiments, several features of the components described herein were previously not possible due to manufacturing constraints. However, the present inventors have advantageously utilized current advances in additive manufacturing techniques to develop exemplary embodiments of such components in accordance with the present disclosure. While the present disclosure is not limited to the use of additive manufacturing to form these components generally, additive manufacturing does provide a variety of manufacturing advantages, including ease of manufacturing, reduced cost, greater accuracy, etc.

Further aspects of the invention are provided by the subject matter of the following clauses:

A turbomachine including a compressor section, a combustion section including a combustor, the combustor including an end cover and a fuel nozzle; and a turbine section, wherein the fuel nozzle includes a plurality of mixing tube elements surrounded by a housing, at least one of the plurality of mixing tube elements including a body extending between a first end and a second end and defining a passage extending through the body between the first end and the second end, wherein the first end is closed and the second end is open, the body further defining a first fluid inlet and a second fluid inlet, the first fluid inlet defined between the first end and the second end, the second fluid inlet defined between the first fluid inlet and the second end.

A fuel nozzle (22) for a combustor (10) of a turbomachine (100), including a housing (210) and a plurality of mixing tube elements (230, 300) surrounded by the housing (210), at least one of the plurality of mixing tube elements (300) including a body (302) extending between a first end (304) and a second end (306) and defining a passage (308) extending through the body between the first end (304) and the second end (306), wherein the first end (304) is closed and the second end (306) is open, the body (302) further defining a first fluid inlet (320) and a second fluid inlet (330), the first fluid inlet (320) defined between the first end (304) and the second end (306), the second fluid inlet (330) defined between the first fluid inlet (320) and the second end (306).

The turbomachine (100) or fuel nozzle (22) of any one or more embodiments described herein, wherein the fuel nozzle (22) comprises a forward plate (231) and an aft plate (232) axially spaced from the forward plate (231), such that the forward plate (231) and the housing (210) define a first fluid plenum (212) upstream of the forward plate (231), and such that the forward plate (231), the housing (210), and the aft plate (232) collectively define a second fluid plenum (222) between the forward plate (231) and the aft plate (232).

The turbomachine (100) or fuel nozzle (22) of any one or more embodiments described herein, wherein the first fluid inlet (320) is an elongated slot having a major axis oriented in an axial direction, the first fluid inlet (320) being in fluid communication with the first fluid plenum (212).

The turbomachine (100) or fuel nozzle (22) of any one or more embodiments described herein, wherein the first fluid inlet (320) is a plurality of first fluid inlets (320) in fluid communication with the first fluid plenum (212).

The turbomachine (100) or fuel nozzle (22) of any one or more embodiments described herein, wherein the plurality of first fluid inlets (320) is approximately equally spaced about a perimeter of the body (302).

The turbomachine (100) or fuel nozzle (22) of any one or more embodiments described herein, wherein the plurality of first fluid inlets (320) is four first fluid inlets.

The turbomachine (100) or fuel nozzle (22) of any one or more embodiments described herein, wherein the second fluid inlet (330) is in fluid communication with the second fluid plenum (222).

The turbomachine (100) or fuel nozzle (22) of any one or more embodiments described herein, wherein the passage (308) defines a maximum length (310) from the first end (304) to the second end (306) and a maximum width (312), and wherein the maximum length (310) is less than or equal to approximately two times the maximum width (312).

The turbomachine (100) or fuel nozzle (22) of any one or more embodiments described herein, wherein the passage (308) defines a maximum length from the first end (304) to the second end (306) and a maximum width (312), and wherein the maximum length (310) is equal to approximately two times the maximum width (312).

The turbomachine (100) or fuel nozzle (22) of any one or more embodiments described herein, wherein the at least one of the plurality of mixing tube elements (230, 300) is the plurality of mixing tube elements.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. A turbomachine, comprising:
a compressor section;
a combustion section comprising a combustor, the combustor comprising an end cover and a fuel nozzle; and
a turbine section,
wherein the fuel nozzle comprises a plurality of mixing tube elements surrounded by a housing, at least one of the plurality of mixing tube elements comprising a body extending between a first end and a second end and defining a passage extending through the body between the first end and the second end, wherein the first end is closed and the second end is open, the body further defining an air inlet and a fuel inlet, the air inlet is an elongated slot having a major axis oriented in an axial direction, the air inlet defined forward of the fuel inlet, the fuel inlet defined between the air inlet and the second end.

2. The turbomachine of claim 1, wherein the fuel nozzle comprises a forward plate and an aft plate axially spaced from the forward plate, such that the forward plate and the housing define an air plenum upstream of the forward plate, and such that the forward plate, the housing, and the aft plate collectively define a fuel plenum between the forward plate and the aft plate.

3. The turbomachine of claim 2, wherein the air inlet is in fluid communication with the air plenum.

4. The turbomachine of claim 2, wherein the air inlet is a plurality of air inlets in fluid communication with the air plenum.

5. The turbomachine of claim 4, wherein the plurality of inlets is approximately equally spaced about a perimeter of the body.

6. The turbomachine of claim 4, wherein the plurality of air inlets is four air inlets.

7. The turbomachine of claim 2, wherein the fuel inlet is in fluid communication with the fuel plenum.

8. The turbomachine of claim 1, wherein the passage defines a maximum length from the first end to the second end and a maximum width, and wherein the maximum length is less than or equal to two times the maximum width.

9. The turbomachine of claim 1, wherein the passage defines a maximum length from the first end to the second end and a maximum width, and wherein the maximum length is equal to approximately two times the maximum width.

10. (canceled)

11. A fuel nozzle for a combustor of a turbomachine, comprising:
a housing; and
a plurality of mixing tube elements surrounded by the housing, at least one of the plurality of mixing tube elements comprising a body extending between a first end and a second end and defining a passage extending through the body between the first end and the second end, wherein the first end is closed and the second end is open, the body further defining an air inlet and a fuel inlet, the air inlet is an elongated slot having a major axis oriented in an axial direction, the air inlet defined forward of the fuel inlet, the fuel inlet defined between the air inlet and the second end.

12. The fuel nozzle of claim 11, wherein the fuel nozzle comprises a forward plate and an aft plate axially spaced from the forward plate, such that the forward plate and the housing define an air plenum upstream of the forward plate, and such that the forward plate, the housing, and the aft plate collectively define a fuel plenum between the forward plate and the aft plate.

13. The fuel nozzle of claim 12, wherein the air inlet is in fluid communication with the air plenum.

14. The fuel nozzle of claim 12, wherein the air inlet is a plurality of air inlets in fluid communication with the air plenum.

15. The fuel nozzle of claim 14, wherein the plurality of air inlets is approximately equally spaced about a perimeter of the body.

16. The fuel nozzle of claim 14, wherein the plurality of air inlet is four air inlets.

17. The fuel nozzle of claim 12, wherein the fuel inlet is in fluid communication with the fuel plenum.

18. The fuel nozzle of claim 11, wherein the passage defines a maximum length from the first end to the second end and a maximum width, and wherein the maximum length is less than or equal to two times the maximum width.

19. The fuel nozzle of claim 11, wherein the passage defines a maximum length from the first end to the second end and a maximum width, and wherein the maximum length is equal to approximately two times the maximum width.

20. (canceled)

21. The combustor of claim 2, wherein the fuel nozzle comprises a conduit connected to the end cover and extending through the forward plate, the conduit defining a fluid passage in fluid communication with the fuel plenum.

22. (canceled)

23. The combustor as in claim 21, wherein the conduit is connected to the end cover and extends between at least two mixing tube elements.
